(19) United States
(12) Patent Application Publication
(10) Pub. No.: US 2008/0314070 A1
(43) Pub. Date: Dec. 25, 2008

(54) Flexible sorption cooling elements

(75) Inventors: Peter Maier-Laxhuber, Pfaffenhofen (DE); Ralf Schmidt, Freising (DE); Dipl.-Ing Reiner Worz, Reichertshausen (DE); Andreas Becky, Ottobrunn (DE); Gert Richter, Klitten (OT Tauer) (DE); Norbert Weinzierl, Freising (DE); Manfred Binnen, Munchen (DE)

Correspondence Address: HOFFMANN & BARON, LLP, 6900 JERICHO TURNPIKE, SYOSSET, NY, 11791, US

(73) Assignee: ZEO-TECH Zeolith-Technologie GmbH.

(21) Appl. No.: 12/157,002

(22) Filed: Jun. 5, 2008

(30) Foreign Application Priority Data
Jun. 19, 2007 (DE) DE 102007028559.2
Oct. 19, 2007 (DE) DE 102007050134.1

(51) Int. Cl. F25B 17/08; B23P 15/26

(52) U.S. Cl. 62/480; 29/890.035

(57) ABSTRACT

A cooling element with a sorption agent (11, 33) that, under vacuum, can sorb a vapor working agent, which evaporates from a liquid amount of working agent in an evaporator region (16, 22), and with a shutoff device, which, before initiating the cooling process, keeps the working agent vapor from being able to flow to the sorption agent (11, 33), and where the sorption agent (11, 33) and the evaporator region (16, 22) are surrounded by a multilayer film (1, 6, 31, 32) and the evaporator region (16, 22) contains a nonwoven (5, 36) and a flexible structural material (2, 35), which together can take on a flat flexible shape under vacuum, that can be pressed onto the containers (14, 24) that are to be cooled, and the structural material (2, 35), after the start of the cooling element, can conduct the working agent vapor up to the sorption agent (11, 33) and keep a flow cross section of at least 1 square centimeter (cm²) open for the working agent vapor.

### BACKGROUND OF THE INVENTION

The invention concerns sorption cooling elements with a gas-tight film for cooling containers, in which cold is generated by the evaporation of a working medium and sorption of its vapor in a sorption agent under a vacuum, and a method for producing and for starting these cooling elements.

Adsorption devices are apparatus in which a solid adsorption agent sorbs a second lower boiling agent, the vapor working agent, while releasing heat. The working agent in this case evaporates in an evaporator while absorbing heat. After the sorption agent has become saturated, it can again be desorbed by supplying heat at higher temperatures (desorption phase). In doing so, the working medium evaporates from the adsorption agent. The working medium vapor can be re-liquefied and then evaporated anew.

Absorption devices are apparatus in which a liquid absorption agent is used. Both adsorption and absorption systems fall under the term “sorption devices.”

Adsorption apparatus for cooling with solid sorption agents are known from EP 0 368 111 and DE-OS [Offenlegungsschrift Patent Application] 34 25 419. Sorption agent containers filled with sorption agents take up the working agent vapor, which arises in an evaporator, and sorb it while releasing heat. This heat of sorption must then be withdrawn from the sorption agent. The cooling apparatus can be used to cool foods and to keep foods warm in thermally insulated boxes.

WO 01/10738 A1 describes a self-cooling beverage can in which an evaporator is arranged within and a sorber is arranged outside of the can. Cooling is initiated by opening a vapor channel between the evaporator and the sorber. The cold generated in the evaporator is given up via its surfaces to the beverage that is to be cooled within the can. The heat that arises in the sorption agent is stored in a heat buffer. The self-cooling beverage can is highly modified by comparison with an ordinary can and is expensive to make.

Other theoretical designs of self-cooling packaging are summarized in WO 99/37958 A1. None of these devices is cheap to make.

Finally, U.S. Pat. No. 6,474,100 B1 describes a self-cooling element on the outside of a pouch for liquids or bulk goods. The sorption agent in this case is enclosed in a flexible, multilayer film. Contact via the hot sorption filling is reduced to a minimum by insulation and wicking materials and by heat storage masses lying in between. The temperature balance between the hot sorbent filling and the cold evaporator, which face each other over a large area, must be reduced by expensive insulation.

The task of the invention consists of inexpensive, flexible sorption cooling elements, and a method for making them.

### SUMMARY OF THE INVENTION

This task is solved by the characterizing traits of Claim 1. The dependent claims point to other inventive devices and methods.

In accordance with the invention, the sorption agent and the evaporator are surrounded by a multilayer film. The evaporator contains a nonwoven material and a flexible, vapor-permeable structure material, which together under vacuum have a flat, but flexible geometry that can easily be pressed against any container that is to be cooled. After the initiation of the cooling element the structural material guides the working agent vapor to the sorption agent and leaves open a flow cross section of at least 1 cm² for the working agent vapor.

Through the use of a low-cost structural material on the one hand, a flexible construction of the evaporator can be realized, one that can optimally be matched in particular to cylindrical geometries, and on the other hand the necessary flow channel from evaporator to sorption agent can be realized in the required cross section. To achieve sufficiently rapid cooling, the flow cross section must have an area of 1 square centimeter (cm²). If water is used as the working agent, a refrigerating capacity of more than 20 watts can be generated.

The multilayer film necessary for the gas-tight vacuum envelope holds all of the components necessary for operation and the storage time. If necessary, it can be made in a single piece and the inner flexible components ensure the required freedom of motion under vacuum. Storage times of over a year are possible with an aluminum shutoff layer in the multilayer film without too great an amount of gas diffusing through the film during the storage time.

For rapid cooling of a liquid in a container in accordance with the invention, the evaporator surface of the cooling element is pressed against the outer surface of the container. The evaporator is designed to be flexible for this and the cold evaporator surface is pressed flat against the outer surface of the liquid container by means of a separate elastic pressure means in order to utilize a large portion of the sometimes highly structured surface of the container for heat exchange.

Adhesive tapes, stretch or shrink films, as well as rubber bands or hook-and-loop closures of any kind, for example, are suitable as pressure means. With this solution it is advantageous that the liquid container can remain partially visible and the cooling element does not have to be opened or removed in order to pour the liquid out. When the cooling element is placed against the container, care must be taken that the heat transfer between the outside of the container and the evaporator surface is not unnecessarily adversely affected by gaps and folds.

Container is understood to mean all conventional vessels such as bottles, cans, drums, pouches, pots, cardboard packages, etc., that are used to hold liquids such as beverages, medications or even chemical products. Of course, the container can also contain solid or bulk products. Basically speaking, the container does not need to be modified from its usual shape and design. Thus, all previously used manufacturing and filling devices can continue to be used without modification.

In principle, the evaporator can have any shape and can be made of any material. During the cooling process it is technically necessary that there be an opening sufficiently large for outflow of the water vapor into the sorption agent, the working agent remain in liquid state at the site to be cooled, entrainment of liquid components into the sorption agent be prevented and that a good thermal connection to the object to be cooled remain.

Especially low-cost cooling elements can be achieved if all of the components are welded together into one-and-the-same gas-tight film. Under vacuum, the flow channels to the sorption agent must continue to exist. For this a vapor-permeable structural material is provided that lets the working agent vapor flow unhindered from the liquid amount of working agent and, at the same time, due to its flexibility, that allows the cold evaporator regions to be in good heat-conductive contact with the outer multilayer film in accordance with the invention.

Flexible structural materials of plastic that are matched to the relevant cooling job can be advantageously used for this. However, a prerequisite is that during the storage time the structural materials do not outgas and thereby degrade the vacuum. It is advantageous if polycarbonate or polypropylene is used as the plastic, since these materials were heated to higher temperatures before or during the manufacturing process and in so doing were degassed.

Structural materials of plastic can be produced at low cost by conventional manufacturing processes like deep drawing, extrusion or blow molding. Value is added by the fact that no substances that outgas later such as plasticizers or dyes are added in the manufacturing process. Also, extruded networks and lattices of polypropylene have proved to be particularly efficient; used in single or multiple layers, these ensure, for one thing, the required flexibility with regard to deformation and, for another, the stiffness with regard to the air pressure applied from outside via the multilayer film. Especially suitable structural materials of polypropylene are sold by Tenax Germany. The product OS 102 is a diamond lattice, which leaves open ideal geometries for the working agent vapor flowing in the plane of the lattice and supports the multilayer film lying on the outside. Two-layer and multiple-layer lattices can be used as structural material with particular advantage.

Sorption agents can reach temperatures of over 100° C. in the sorption process. The multilayer films that are usually used in the packaging sector are less suitable for such high temperatures. In particular, the polyethylene layers that are often used for sealing already become soft at 80° C. and let the envelope become leaky under vacuum. On the other hand, sealing layers of polypropylene can withstand clearly higher temperatures. Their melting point is over 150° C.

In combination with high temperatures, the sharp edges, corners and sharp tips of the sorption agent granulate can generate impermissible leakages. In accordance with the invention, this danger can be combated by means of polyamide and/or polyester layers within the multilayer film. Polyester and polyamide films are especially tear-resistant and puncture-resistant. The actual gas shutoff is established by a layer of thin metal films or metallized layers. For this, thin aluminum foils with a layer thickness of about 8 μm have shown merit. Metallized plastic film are less gas-tight. Nevertheless, for short storage periods, the use of these metallized films is also possible, particularly since they can be made more cheaply than the metal films.

The individual layers of a multilayer film are bonded together by adhesives. Commercial adhesives contain solvents that are not completely removed from the adhesive layer in the gluing process. Over longer periods of time, these solvents then diffuse through the inner layers, especially the polyethylene layer, and have an adverse effect on the vacuum within the cooling element. Diffusion increases at higher temperatures, such as arise in the sorption process and the manufacturing process of the cooling elements. The adhesives that can be used therefore must be designed both for high temperatures and vacuum.

In accordance with the invention, multilayer films with polyester or polyamide layers from 12 to 50 μm thick, an aluminium layer of 8 μm thick and a polypropylene layer of 50 to 100 μm thick can be used. Such films are used, for example, for packaging foods, which are sterilized after packaging at temperatures over 120° C. in order to make them keepable.

Still more stable multilayer films are obtained if an additional approximately 15 μm thick polyester or polyamide layer is bonded between the aluminum and the polypropylene layer. Then sharp or pointy sorption agent particles cannot then penetrate to the gas barrier, the aluminum layer.

Multilayer films in accordance with the invention can be obtained, for example, from Wipf A G in Volketswil, Switzerland. Cooling elements with a leakage rate less than 1×10⁻⁷ mbarl/sec are possible when using such films. With that the storage capacity reaches several years without a reduction in the refrigeration effect.

The welding of multilayer films to pouches and filling them with bulk material as well as the subsequent evacuation are prior art in the food industry.

Pouches in a wide range of sizes and shapes are in use for this. One may mention in particular here, stand up pouches, pouches with a pouring spout, pouches with cardboard reinforcement, tear-open pouches, pouches with peel effect for easier opening and pouches with valves. With their specific properties, they can all be of advantage for the cooling elements in accordance with the invention.

When solid sorption agents are filled into pouches, dust forms and can deposit on the inside of the film. Dust on the subsequent welding sites may lead to leakages if the dust layer is too thick by comparison with the polypropylene layer. Polypropylene layers that are 50-100 μm thick are sufficient to melt fine dust particles into the polypropylene layer reliably and vacuum tight.

When using films in accordance with the invention, it is possible to envelope hot, sharp-edged and dust-releasing sorption agent directly under vacuum without additional protective intermediate layers and to store them over a period of several years, without foreign gases getting into the cooling element from the film material itself or passing through it, which can adversely affect the sorption reaction or even suppress it entirely. The sealing seams here should have a width of at least 5 mm, with 10 mm being even better.

Zeolite can advantageously be used as sorption agent. In its regular crystal structure, it can reversibly sorb up to 36% by weight water. When used in accordance with the invention, the technically realizable water uptake amounts to 20 to 25%. Even at relatively high temperatures (over 100° C.), zeolites still have a considerable water vapor sorption capacity and therefore are particularly suitable for use in accordance with the invention.

Zeolite is a crystalline mineral that consists of a regular framework structure of silicon and aluminium oxides. This framework structure contains vacant spaces in which water molecules can be sorbed while releasing heat. Within the framework structure, the water molecules are subjected to strong field forces, the strength of which is dependent on the amount of water already contained in the framework structure and the temperature of the zeolite.

Natural types of zeolite that occur in nature absorb clearly less water. Only 7 to 11 g water is sorbed per 100 g of natural zeolite. This reduced water absorption capacity is due on the one hand to their specific crystal structures and on the other hand to nonactive contaminants in the natural product. For this reason synthetic zeolites with their greater sorption capacity are preferred for cooling elements that also have the capacity of giving up the heat absorption via the envelope during a lengthy cooling period. For cooling elements with high refrigeration capacity and/or short refrigeration time, in which the sorption agent remains relatively hot, it is also possible to use natural zeolites in accordance with the invention. Specifically, synthetic zeolites are no longer advantageous over the natural ones in the case of high sorption agent temperatures. Typically, both types of zeolites can sorb only 4 to 5 g water vapor per 100 g dry sorption agent weight when there is limited release of the heat absorption and the accompanying high sorption agent temperatures of over 100° C. In this case the natural representatives even have an economic advantage, since their price is considerably lower.

Natural zeolites have still another advantage. The nonactive contaminants typically make up 10 to 30% of the zeolite. They do not actively participate in the generation of cold, but nevertheless they become heated by the adjacent zeolite crystals. They thus act like an additional built-in low-cost heat buffer. The result is that the zeolite filling does not become as hot and thus can sorb additional water vapor at lower temperatures.

A natural zeolite granulate consists of broken or crushed fragments and thus has sharp and pointed geometric shapes that can puncture or cut through the envelope under vacuum and at elevated temperatures.

With zeolites there is also the danger that, in each case according to the synthesis process, occurrence, and decomposition process, they will contain admixture components that give up gaseous components in a vacuum and especially at higher temperatures, and these gaseous components can affect the cooling process.

This problem of gas release is solved by heating the zeolites at least to the subsequent sorption agent temperature before making the cooling element and at the same time subjecting them to the vacuum that will prevail then. With this procedure, zeolites in accordance with the invention can give up their problematic components. This thermal treatment is especially efficient if the presorbed water can be evaporated out at the same time. To be able to conduct this treatment at elevated temperatures and to be able to withstand the sharp edges and sharp tips, in accordance with the invention gas-tight multilayer films with an inner polypropylene layer and at least one polyester layer are used. Hot sorption agents can also be filled into these films.

Among the approximately 30 different natural zeolites, the following can be advantageously used for the cooling elements in accordance with the invention: clinoptilolite, chabazite, mordenite and phillipsite. They are very common, are inexpensive to process, and have a sufficiently rapid sorption characteristic.

Substances that occur in nature can also be returned to nature without environmental considerations. After they have been used in cooling elements, natural zeolites can be used, for example, as soil amendments, as liquid binders or to improve the water quality in ponds and other bodies of waters.

Of the synthetic zeolites types A, X and Y, each in the low-cost Na form, are used.

Besides the combination of zeolite and water, other solid sorption agent pairings are also possible for use in cooling elements in accordance with the invention. One may mention in particular bentonites and salts, which likewise represent combinations that are appropriate with water as the working agent. Activated carbon in combination with alcohols can also offer an advantageous solution. Since these substance pairs work even at reduced pressure, they can be welded into multilayer films in accordance with the invention.

In accordance with the invention, the amount of sorption agent should be dimensioned and arranged so that only a minimal pressure drop has to be overcome within the sorption agent for the incoming water vapor. Here, the pressure drop should be less than 5 mbar, especially if water is used as the working agent. Moreover, the sorption agent must offer sufficient surface for storage to the flowing working agent vapor. Sorption agent granulates in particular have shown themselves able to ensure uniform sorption within the sorption agent and a low pressure drop. Granulate diameters between 3 and 10 mm show the best results. These can be packed in film pouches without any problem. After evacuation, they form a hard, pressure-resistant and shape-stable sorption container that retains the shape imposed in the evacuation process. However, stable zeolite blocks that have been preformed from zeolite powder, in which the flow channels are already built-in and the shape of which is matched to the desired cooling element geometry are also advantageous. The stable zeolite blocks can have vacant spaces in the region of the subsequent vapor opening that facilitate the penetration of the film using a cutting tool and can accept the separated piece of film so as not to hinder flow through the vapor channel.

In the sorption reaction, heat absorption is released and heats the sorption agent. The capacity for absorption of working agent drops off sharply at higher sorption agent temperatures. To be able to maintain high refrigeration capacity over a longer period of time, it is important to cool the sorption agent.

If there is direct contact between the sorption agent and the multilayer film, heat absorption that develops can be dissipated outwardly through the film. As a rule, the heat is given up to the surrounding air. It is also very efficient to cool the sorption container by means of liquids, especially water.

Since the heat transfer to a flow of air from the outside of the multilayer film is of the same order of magnitude as the heat transfer of a sorption agent granulate to the inner side of the film, in principle large film surfaces without fins are recommended, for example cylindrical, plate or tubular geometries. Since zeolite granulates in particular have low thermal conductivity, the sorption containers should be designed so that the average heat conduction path within the sorption agent does not exceed 5 cm.

Using cooling elements in accordance with the invention, the chilling of a 0.75 L champagne bottle from 25° C. to 10° C. can take place within a period of 30 minutes, for example.

After manufacture, the cooling elements can be stored at room temperature for an indefinite period of time. The shutoff device is activated at the starting point of the cooling effect. Starting at this time, the working agent vapor can flow to the sorption agent and be taken up by it. The sorption agent becomes hot since it liquefies and stores the vapor within its crystal structure. Through the evaporation, the evaporator cools and withdraws sensible heat from the liquid container via the outer jacket. During the relatively short cooling period it will not be possible to cool the sorption agent to a significant degree. The capacity for absorption of working agent vapor will therefore be limited if admixture components do not function as a heat buffer.

If a longer refrigeration maintenance time follows the rapid cooling of the contents of the bottle, the sorption agent will also be able to give up heat through the multilayer film.

In accordance with the invention, in these applications the heat of sorption at a higher temperature level can also be transmitted to a product that is to be kept warm.

To minimize the heat flow from the hot sorption agent to the cold evaporator, either insulation materials are provided or care is taken in accordance with the invention to provide sufficient spacing between the two components.

Thermal insulation of the evaporator surrounding the liquid container is also a desirable objective. If the container and the evaporator are not insulated from the ambient air, condensation of water vapor from the air onto the cold surfaces can occur. For one thing, moisture that precipitates between the container and evaporator can improve the heat transfer from the container to the evaporator, but on the other hand a considerable portion of the cooling capacity for the condensation is lost.

In accordance with the invention, the cooling elements can be divided into structural types A and B with regard to their shutoff device:

A: The working agent is already contained in the evaporator nonwoven. To start the cooling effect, the vapor channel from evaporator to sorption agent is opened, for example, by rupturing a sorption agent pouch that contains the sorption agent and is arranged within the multilayer film.

B: The working agent is situated outside the evaporator nonwoven. To start the cooling effect, a working agent connecting line from a working agent pouch to the evaporator is opened; for example, by puncturing the working agent pouch and squeezing the working agent out into the evaporator.

In the first instance (A), either a valve must be connected between the evaporator nonwoven and the sorption agent region, or the sorption agent must be situated within an additional multilayer film pouch, which must be opened in the direction of the evaporator to start the cooling function. Sharp-edged cutting tools that puncture a sufficiently large opening in the sorption agent pouch are suitable for this. The cutting tool in this case can act on the film both from the sorption agent side as well as from the evaporator side. Since the films in accordance with the invention are flexible, the cutting tool in accordance with the invention is actuated by a change of shape produced on the multilayer film from outside. With that, all shutoff devices can be made cheaply and actuated in a gas-tight way.

In principle, the cutting tool must be sharp enough to cut through the film in the necessary cross section. For example, cylindrical expanded metals or sharp-edged molded parts of plastic that are also additionally able to pinch or shift the sorption agent situated behind the film in order to cut through the film in a large area are suitable. In order to cut a sufficiently large opening, at least 1 cm² in size, using the cutting tool, it is possible, for example, to use a rubber hammer to strike the multilayer film covering the cutting tool.

In the second case (B) only a small opening need be made in the working agent pouch and a connecting line must be provided for the still-liquid working agent to go to the evaporator nonwoven.

In accordance with the invention, additional liquid working agent can be filled into the surrounding multilayer film in the appropriate amount and in a connecting channel. The connecting channel can in accordance with the invention be sealed by the surrounding multilayer film being folded in this region one or several times, so that its sealing layers lie tightly against one another. Together with the air pressure applied from outside pressure, this measure provides a sufficient seal between the liquid working agent and the evaporator nonwoven. To make the opening, one merely needs to refold the enveloping multilayer film back to the original flat form in the channel region and partially squeeze the working agent into the evaporator by additional pressure on the working agent pouch.

Another advantageous embodiment is obtained if a working agent pouch filled with the required amount of work agent is placed between the multilayer film inside or outside the evaporator region. This pouch can be burst by outside pressure on the multilayer film in the region of the pouch so that the liquid working agent escapes into the evaporator nonwoven. Bursting via outside pressure can take place either through the use of a film with peel effect or by putting a pointed opener in the working agent pouch. In a completely filled working agent pouch the pointed opener cannot press against the film and perforate it during storage. Only through the effect of an additional external force in the region of the opener will the liquid working agent be displaced so that the pointed opener can puncture a small opening in the film. If the working agent pouch is made of a film with peel effect, a separate opener can be omitted since the sealing seam can be made to leak and let the contents flow out by vigorous force on the pouch due to the peel effect. The physical rupture properties of the peel-seal seam can be tailored to the requirements of the working agent pouch. Here, one must ensure that the air pressure applied from outside does not burst the pouch, but the pouch lets the contents flow into the evaporator when appropriately high finger pressure is applied. The connecting channel to the evaporator, which can be of any length and can be optimally matched to the relevant geometries that are present, can be held open by a narrow strip of structural material or a flexible plastic tube.

In accordance with the invention, the adsorbable amount of working agent can be held in more than just one single working agent pouch. This gives the possibility of being able to use a cooling element for cooling more than once by opening just one working agent pouch each time. This is of particular advantage in the case of cooling tasks that have high cooling capacities. Due to the high adsorption power, the heat of adsorption in this case cannot be withdrawn from the sorption agent sufficiently rapidly. The adsorption capacity can thus not be fully utilized. However, if the sorption agent has recooled after the first cooling process, it can again adsorb the working agent. For this, a second (or additional) working agent pouch can in turn be opened any time and deliver its contents to the evaporator nonwoven. Each working agent pouch in this case is filled only with a partial amount of the amount of working agent that can maximally be adsorbed by the sorption agent.

In the last embodiments, the evaporator together with the sorption agent can be put into a single multilayer film that surrounds the whole. Only when the liquid working agent advances from the working agent pouch to the evaporator can it evaporate from there and flow further to the sorption agent in vapor form.

The advantage of this shutoff device lies in the fact that only a relatively small flow cross section is required for the liquid working agent. On the other hand, it is disadvantageous that the working agent has to wet the evaporator homogeneously and sufficiently rapidly without being entrained in liquid form into the sorber or even without freezing up at the outlet from the opening of the working agent pouch and thus blocking further flow.

In accordance with the invention, water as the working agent can be kept from freezing by adding an agent that lowers the freezing point. Adding common salt can reduce the freezing point to −17° C., for example. It is also helpful if the freezing point-lowering agent is arranged outside of the working agent pouch, around the outlet opening. Then the water will mix with the freezing point-lowering agent in a high concentration only when it leaves the opening. This prevents the solidification. Water moving in the wake will then dilute the solution and transport the working agent into all regions of the evaporator.

Homogeneous distribution of the working agent can also be achieved in accordance with the invention by a separate, finely branched channel structure that distributes the working agent homogeneously after it flows out from the working agent pouch before it can be entrained in liquid form by the vapor flow. A low-cost distribution can be achieved, for example, by a layer of film with fine perforations that is arranged around the outlet orifice.

An especially efficient, and at the same time low-cost, solution is achieved when the liquid working agent becomes homogeneously distributed in the evaporator nonwoven by the structural material of the vapor channel. For this, after opening the working agent pouch, the working agent is pressed out into the structural material by excess pressure applied to the multilayer film from outside. Here, a part of the working agent evaporates and entrains the still-liquid working agent at high speed. If the structural material is shaped in accordance with the invention, the liquid working agent is repeatedly deflected on the path toward the sorption agent and continues to be thrown against the adjacent nonwoven material. This material absorbs the liquid components of the working agent and secures it from the working agent vapor that is flowing by. In this way, the evaporator nonwoven becomes homogeneously wetted with the optimum amount of working agent in the shortest time. The transport of the liquid working agent consequently takes place not within the evaporator nonwoven, but rather via the vapor channel within the structural material. Advantageously, the evaporator becomes flooded from below with the liquid working agent while the pure working agent vapor flows out from the evaporator above. However, the evaporator does not necessarily have to stand upright. However, in accordance with the invention the feed of the liquid working agent takes place from the one side and the exit of the working agent vapor takes place from the opposite side. The amount of the evaporator nonwoven should be matched to the volume of the liquid working agent. At the end of the outflow operation, the area of the evaporator nonwoven that is in contact with the container should have absorbed the necessary amount of working agent.

The working agent is fixed in the evaporator nonwoven by hygroscopic effects. Especially cheap nonwoven materials are absorbent papers, such as are used in great diversity for the absorption of liquids for home and industry. Also, the water-storing nonwovens, such as the spacers of plastic or natural zeolite, must not outgas under vacuum and at higher temperatures.

Especially absorbent nonwovens consist of polypropylene microfibers. Provided with special wetting agents, they can absorb and hold several times their own weight in water. Sandler A G, Schwarzenbach, Saale, offers the corresponding nonwoven materials under the product name Sawadry 8313.

Another solution is revealed by securing the working agent in organic binders such as “Water Lock” from Grain Processing Corp. USA. The combination of more than one of these measures can also be advantageous.

To produce cooling elements in accordance with the invention by shutoff valve variation A, a sorption pouch open at one side is produced by thermal welding, for example, from a multilayer film. The sorption agent pouch is filled with sorption agent, which is low in working agent and does not contain gases that can escape and the pouch together with the film is put into the desired geometric shape, evacuated to less than 5 mbar and especially to less than 2 mbar and weld-sealed gas-tight. Then the sorption agent pouch under vacuum, together with a shutoff device, a structural material and an evaporator nonwoven that is soaked with working agent, is packaged in another envelope pouch of multilayer film. The envelope pouch is then evacuated in a vacuum chamber to the vapor pressure of the working agent and then likewise sealed gas-tight. When inserting the shutoff device, care should be taken that its orifice device has not already been triggered when air is admitted into the vacuum chamber.

When using separate working agent pouches (shutoff device variation B), the manufacturing process can be slightly modified. The structural material, the nonwoven and the working agent pouch or pouches are put into specific positions in a multilayer film pouch. In this variation, too, the geometry is matched to the container that is to be cooled before evacuating the evaporator region. Then hot adsorption agent is added and the multilayer film pouch is evacuated and sealed either in the vacuum chamber or by means of a suction adapter.

As a rule, the sealing of the film pouches takes place by pressing hot welding bars against the outer film surfaces until the inner polypropylene layers become soft and melt together. As a rule, the sealing operation takes place in a vacuum chamber under vacuum. However, it is also advantageous to evacuate the pouch outside of the vacuum chamber by means of a tight-fitting suction adapter and then to seal it. Besides thermal contact processes, welding methods using ultrasound are also tried and true. Advantageously, the sealing seam has a width of at least 5 mm, and 10 mm is still better. The wider the sealing seam, the lower the leakage rate and consequently the longer the potential storage time of the cooling element.

### BRIEF DESCRIPTION OF THE DRAWINGS

In the drawings:

FIG. 1 shows the construction (except for the zeolite) of a cooling element in accordance with the invention in an exploded view,

FIG. 2 shows the cooling element in FIG. 1 after partial sealing and before shaping,

FIG. 3 shows the filling of the cooling element in FIG. 2 with hot zeolite granulate,

FIG. 4 shows the evacuated cooling element in FIG. 3 positioned on a bottle that is to be cooled,

FIG. 5 shows a cross section through a cylindrical evaporator,

FIG. 6 shows a lengthwise cross section through the evaporator and working agent pouch,

FIG. 7 shows a cooling element as in FIG. 4 in a perspective view,

FIG. 8 shows another cooling element in accordance with the invention positioned on a small beer keg,

FIG. 9 shows a cross section through the zeolite region of a cooling element as in FIG. 8,

FIG. 10 shows a lengthwise section through the cooling element in FIG. 8 and

FIG. 11 shows the construction of a cooling element as in FIG. 8.

### DETAILED DESCRIPTION OF THE PREFERRED EMBODIMENTS

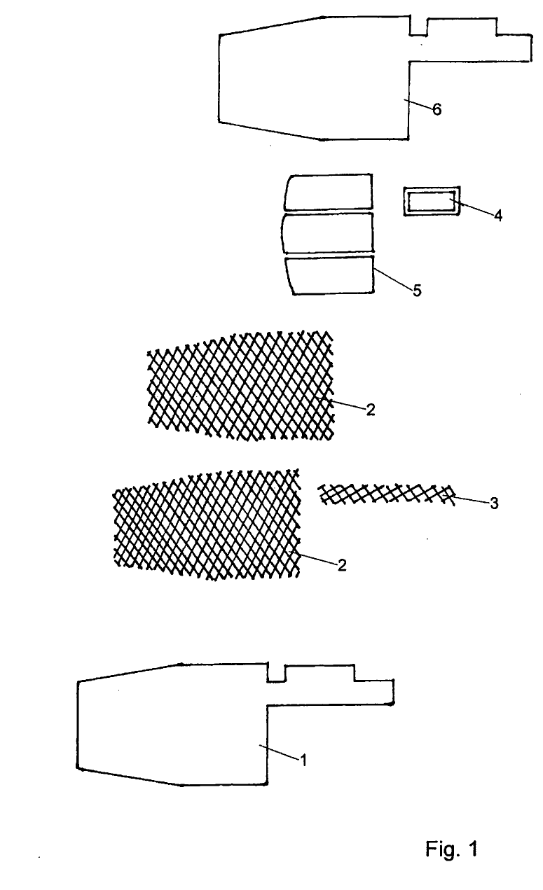

FIG. 1 shows individual components of a cooling element in accordance with the invention in an exploded view. Two layers of a structural material 2, made from a polypropylene network lattice are laid on a stamped-out piece of a multilayer film 1, with the sealing layer facing up. Another small network lattice strip 3 will later form the connecting channel from the working agent pouch 4 to the evaporator nonwoven 5. The evaporator nonwoven 5 consists of a 3-mm-thick microfiber mat of polypropylene. It is cut into three parts and can be fastened to the structural material 2. Finally, the second mirror image-stamped multilayer film 6 forms the upper vacuum-tight envelope. The working agent pouch 4 is likewise made of a multilayer film. It contains 60 g degassed water and a sharp-edged opener. By strong pressure on the pouch in the region of the opener, the opener perforates the pouch film so that only the working agent pouch 4 is perforated in this operation. Care must be taken in placing the pouch so that the sharp edges can act on the film of the working agent pouch 4 only in the region of the network lattice strip 3 without also perforating the outer multilayer films 1 and 6.

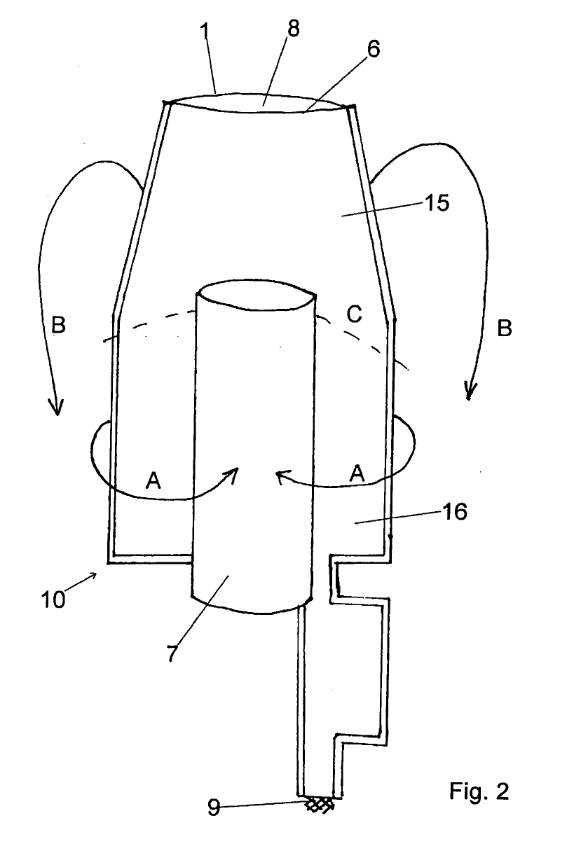

FIG. 2 shows the cooling element from FIG. 1 with the multilayer films 1 and 6 sealed continuously up to the two edges 8 and 9, before it has been formed on cylinder 7. Cylinder 7 has approximately the same dimensions as the bottle that is to be cooled. Arrows A show the direction of wrapping, the evaporator region 16, while arrows B indicate the edge direction of the zeolite region 15. Thus, the initially flat cooling element 10 is brought into a cape-like, three-dimensional shape along dashed line C and fixed in this position before being filled with hot zeolite.

One end of the network lattice strip 3 projects from the still-open edge 9. The second end fits into the structural material two (not visible). Between, is the working agent pouch 4 (likewise not visible). The network lattice strip 3 can have nearly any length in order to position the working agent pouch or pouches 4 at a distance from the evaporator region. If the distances are longer it is also possible to use a thin flexible strip 2 instead of the network lattice strip 3.

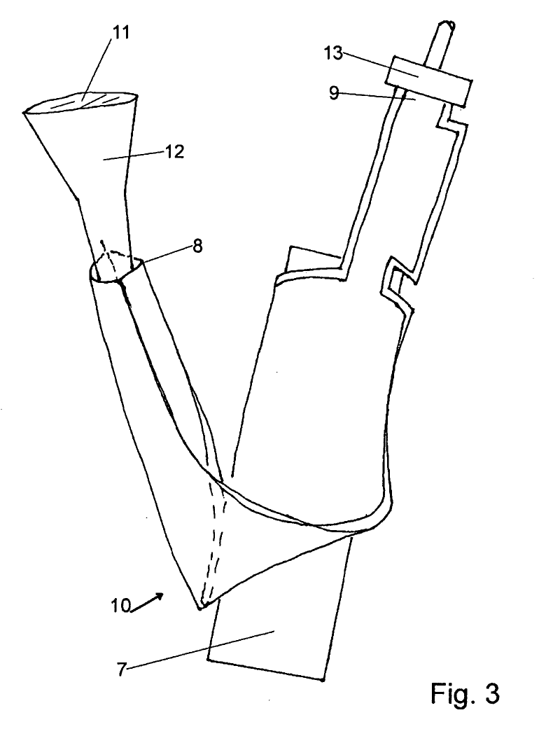

In FIG. 3, about 600 g hot zeolite granulate 11 is being filled using an inflating device 12 over the open edge 8. After sealing the filler edge 8, the cooling element 10 is turned over by 180° and the zeolite granulate is brought into the desired geometry by means of a molded body (not shown). The interspace of the cooling element 10 is evacuated to a pressure of under 2 mbar (absolute) using a suction adapter 13, which is fitted gas tight at the still open edge 9. In so doing, excess water vapor, air and coadsorbed gases are suctioned from the zeolite granulate via the structural material and then via the network lattice strip 3. At the end of the suction operation the open edge 9 is also sealed by means of hot sealing bars pressed against the outside. The material of the network lattice strip 3, which has kept the multilayer films 1 and 6 spaced apart, then melts together with the sealing layers of the multilayer films 1 and 6 to form a gas-tight closure.

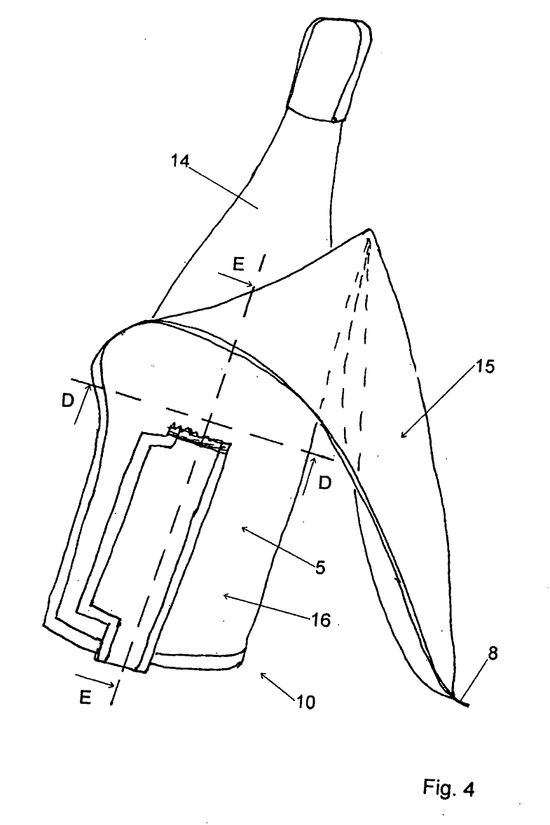

In FIG. 4 the cooling element 10 with its evaporator region 16 is basically placed against the cylindrical part of a bottle 14. The cylindrical evaporator region 16 that contains the evaporator nonwoven 5 surrounds the cylindrical lower part of the bottle. It can be tightened against the bottle wall to produce good heat conduction by means of hook-and-loop strips (not shown). The region of the cooling element that contains the working agent pouch 4 is turned up at the side. The working agent pouch 4 can be perforated by pressure on the opener in the pouch. The water contained in it then follows through the channels that are held open by the network lattice strip 3 and goes to the structural material. The water partially evaporated there carries the still-liquid water within the structural material 3 in the direction of the zeolite filling. Because of the many changes in direction forced on the flow, the entrained water becomes homogeneously distributed in the evaporator nonwoven 5. The water evaporates and cools a large area of the bottle through the multilayer film. The outflowing water vapor is then guided to zeolite region 15 via the of cross section, about 5 cm² total, opened by the structural material. The zeolite filling is heated by this to over 80° C. The sealing layers of the multilayer film of polypropylene maintain this temperature level. They were, after all, more highly stressed during the filling with the hot zeolite. On the other hand, thermal decoupling of the hot zeolite region 15 from the cold evaporator region 16 is important. This takes place on the one hand through the structural material of the flow channel, which is poorly conducting anyway, and also through the geometric distance of the zeolite region 15 compared to evaporator region 16. Not shown, but still important, is thermal insulation of the cold surfaces in order to suppress condensation of atmospheric humidity. The bottle 14 can easily be tilted backward to have a visually pleasant appearance. The necessary support takes place through the zeolite region 15, which contacts the surface on which the bottle stands with the sealing seam at filling edge 8. To serve the contents of bottle 14, it need not be removed from cooling element 10. It can advantageously be tipped via the filling edge 8 together with cooling element 10 and [the contents can be] easily poured into glasses. If the cooling element contains two (or three) working agent pouches, another working agent pouch of the zeolite filling can be opened after the cooling or to cool another bottle.

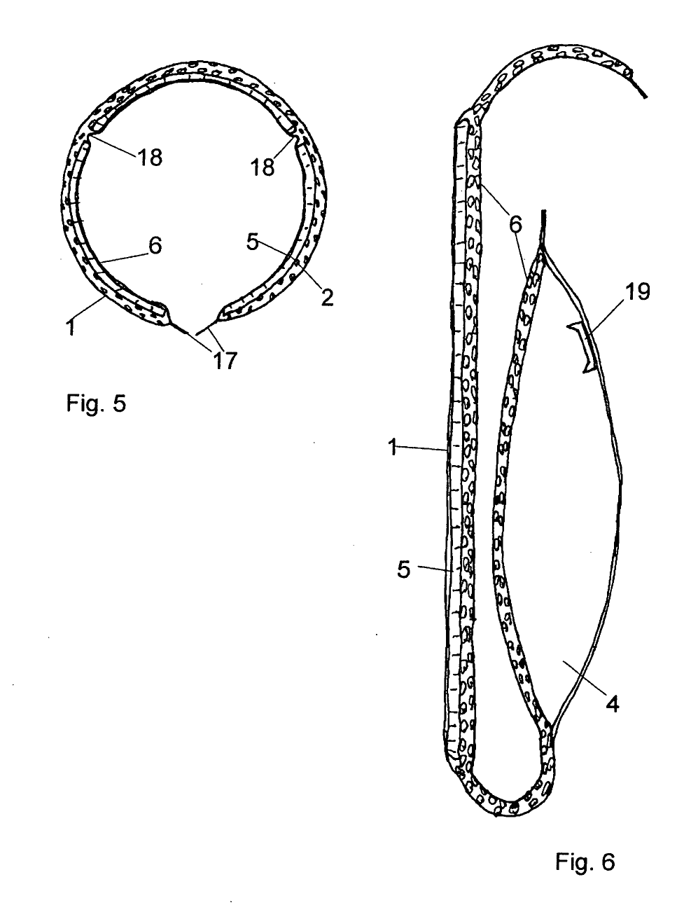

FIG. 5 shows a horizontal section DD through the evaporator region 16 in FIG. 4. The multilayer films 1 and 6 enclose in a circular arrangement the inner evaporator nonwoven 5, which is divided into three parts, and the two layers of the lattice structural material 2. Dividing the evaporator nonwoven 5 produces two lengthwise flutes 18, in addition to the two sealing seams 17. When vacuum is applied, the inner multilayer film 6 is pulled into these flutes 18 and becomes shorter at the two sealing seams 17. Folds in the inner multilayer film 6 are minimized by this. Folds would significantly degrade the thermal contact with the bottle.

FIG. 6 shows the lengthwise section through the evaporator region 16 that is labeled EE in FIG. 4. The multilayer films 1 and 6 again surround the inner evaporator nonwoven 5 and the two layers of structural material 2 as well as the lattice strip 3 and the turned-up, completely-filled working agent pouch 4. This pouch contains an opener 19 secured in the upper region, the sharp points of which can perforate the film of the working agent pouch 4 that lies opposite, by means of external finger pressure. However, the points are not long enough to go through the lattice strip and damage the outer multilayer film 6.

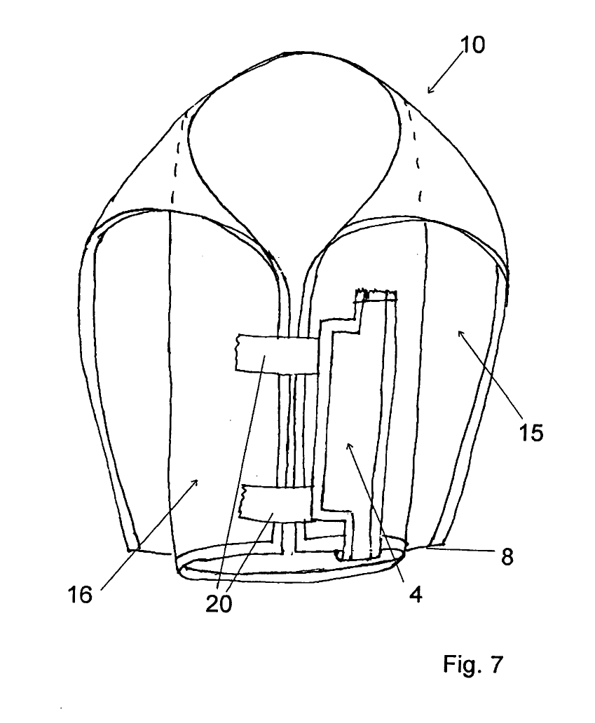

FIG. 7 shows the cooling element 10 in a front view without a bottle. The cape-like shape of the cooling element 10 is clear from this viewpoint. This shape necessarily results if the initially flat individual elements from FIG. 1 are wrapped around a cylindrical shape and at the same time the zeolite region 15 is folded back to the rear. The evaporator region 16 can be modified by means of adhesive strips 20 to form an elastic cooling surface for cylindrical containers, while the zeolite region 15, with its lower sealing edge 8, ensures reliable support at the back. The working agent pouch 4 can easily be reached in order to trigger the cooling function.

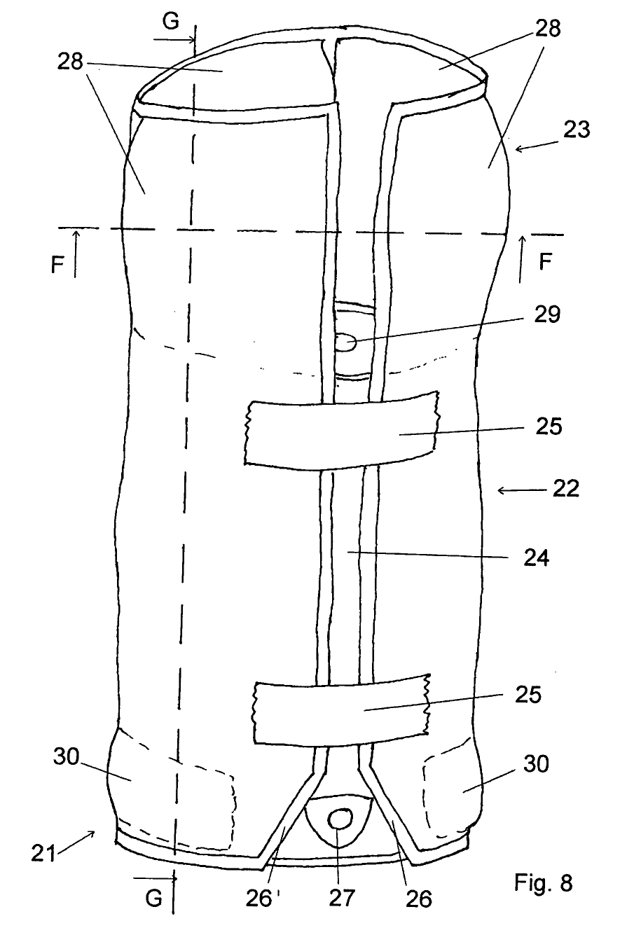

FIG. 8 shows another cooling element 21 in accordance with the invention, the evaporator region 22 of which is wrapped around a small standing beer keg 24 and the zeolite region of which 23 projects above the beer keg. The evaporator region 22 is tightly bound around the bulging outer surface of the beer keg 24 by means of adhesive strips 25. The two lower pouch corners 26 are sealed off at an angle in order to create a place for the bottom tap 27 of the beer keg 24. The zeolite region 23 of the cooling element 21 is divided into four pockets 28, each of which contains zeolite. The air opening 29 arranged in the upper region of the keg 24 is easily accessible from the top in the open region between pockets 28. Two working agent pouches can be recognized by small outward bulges 30 at the lower end of the evaporator region 22. To trigger the cooling function, pressure is exerted on these working agent pouches until their sealing seams burst due to the peel-effect of the film and the degassed water enclosed in them is allowed to flow out into the structural material. The subsequent homogeneous distribution of the water in the evaporator nonwoven progresses in accordance with the invention. Also in this embodiment the cooling operation can be achieved with the opening of just one pouch. The second working agent pouch can be activated at any later time. Of course, each working agent pouch contains only a partial amount of the amount of water that can be maximally adsorbed by the zeolite filling, in order to make available sufficient adsorption capacity for the second cooling operation. The waste heat from zeolite region 23 is given up to the ambient air. Due to the positioning at the top, the warm moist air cannot heat the evaporator region 22.

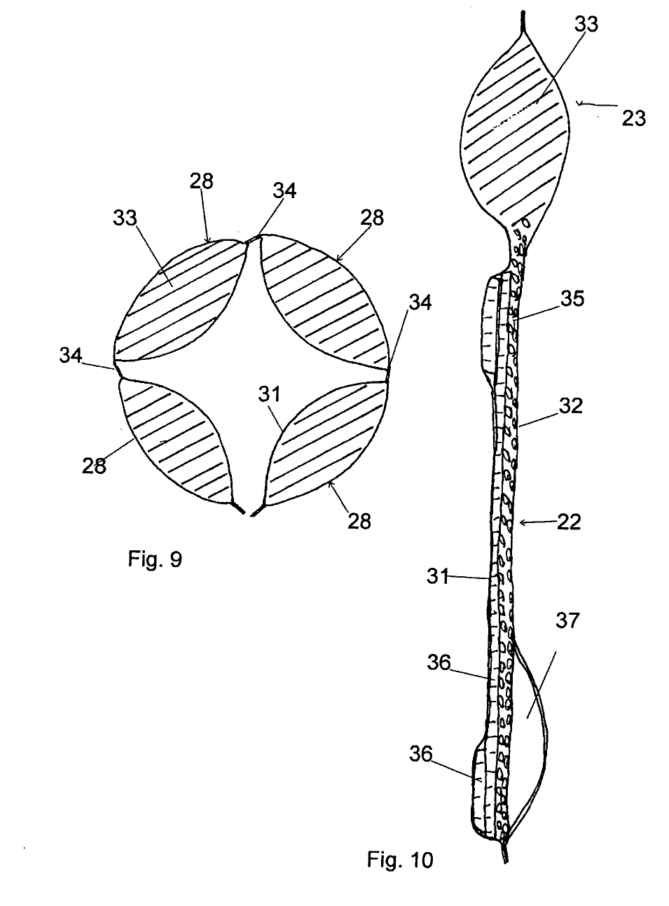

FIG. 9 shows a horizontal section through the zeolite region 23 along line FF in FIG. 8. Inner and outer multilayer films 31 and 32 are sealed so that they form four pockets 28 with zeolite filling 33 that are approximately of the same size. Along the three sealing seams 34, the four pockets are movable against each other. They thus allow the cooling element easily to lie against the beer keg and to be secured there. If the structural material is also divided in the evaporator region in the extension of the sealing seam 34, the entire cooling element can be folded up in a space-saving way and transported before it is applied to the container that is to be cooled.

FIG. 10 shows a lengthwise section through the cooling element 21 along line GG in FIG. 8. The multilayer films 31 and 32 surround the zeolite filling 33 in the upper zeolite region 23, and the structural material 35 in the evaporator region 22, the evaporator nonwoven 36 and the working agent pouch 37. The structural material 35 extends upward to the zeolite filling 33 in order to ensure vapor transport from the evaporator nonwoven 36 into zeolite filling 33. The evaporator nonwoven 36 is arranged in two layers in the upper and lower region in order to ensure optimum binding to an outwardly bulging beer keg. The flexibility of the evaporator region 22 in accordance with the invention in combination with the clamping powers of the adhesive strips leads to an optimum heat-conducted bond to the beer keg.

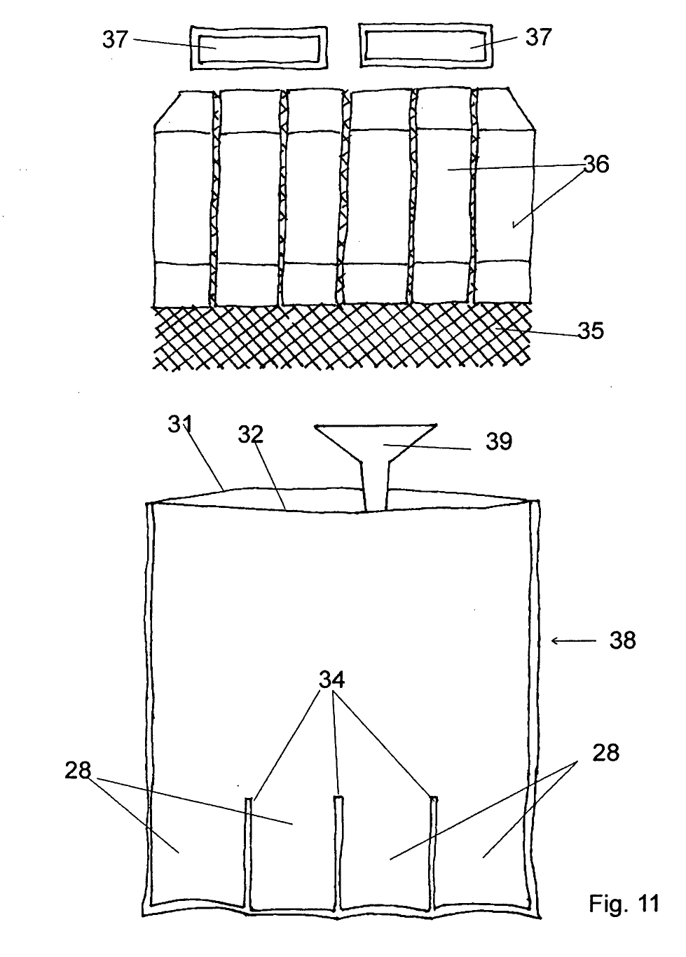

Finally, FIG. 11 shows the individual components of the cooling element 21 before assembly. A pouch 38 of multilayer films 31 and 32, which is matched to the measurements of the beer keg that is to be cooled, has in the lower region four pockets 28 filled with hot zeolite, which are separated laterally from each other by sealing seams 34. The zeolite filling was evenly distributed into the four pockets 28 by means of a funnel device 39. The two-layer structural material is placed on the still-hot zeolite filling. Six slightly spaced evaporator nonwoven pieces 36 are bonded in the structural material 35, each of which is doubled in thickness at the upper and lower ends. The two working agent pouches 37 are secured to the side turned away from the evaporator nonwoven 36.

The cooling element 21 is evacuated in a vacuum chamber to an end pressure of less than 5 mbar (absolute) and the still-open pouch sides are sealed. After removal from the vacuum chamber, the pouch corners 26, which stand in the way of activating the tap, are additionally sealed and then cut off. The cooling element 21 can now be rotated in any position and shaped in accordance with the invention without the zeolite filling 33 (and the incorporated components) leaving their intended positions.

What is claimed is:

1. A cooling element with a sorption agent that under vacuum can sorb a working agent in vapor form, which evaporates from a liquid amount of working agent in an evaporator region, and with a shutoff device, which, before initiating the cooling process, keeps the working agent vapor from being able to flow to the sorption agent,
wherein the sorption agent and the evaporator region are surrounded by a multilayer film and the evaporator region contains a nonwoven and a flexible structural material, which together under vacuum can take on a flat flexible shape, which can be pressed against the containers that are to be cooled and
the structural material, after the start of the cooling element, can conduct the working agent vapor up to the sorption agent and keeps a flow cross section of at least 1 square centimeter (cm²) open for the working agent vapor.

2. A cooling element as defined in claim 1, wherein the multilayer film contains an aluminum shutoff layer and/or a polypropylene sealing layer.

3. A cooling element as defined in claim 1, wherein the structural material has a hollow structure that is sufficiently stable to intercept the air pressure acting on the multilayer film and that also allows a flow of working agent vapor in the surface.

4. A cooling element as defined in claim 1, wherein the structural material can separate the two-phase flow of the working agent into the liquid and vapor phases and can absorb the liquid phase from the close-fitting nonwoven.

5. A cooling element as defined in claim 1, wherein the sorption agent contains a synthetic zeolite and/or natural zeolite.

6. A cooling element as defined in claim 1, wherein the shutoff device contains a cutting tool that is suitable for cutting through a film that holds the sorption agent.

7. A cooling device as defined in claim 1, wherein the working agent is filled into at least one working agent pouch.

8. A cooling element as defined in claim 1, wherein the working agent pouch contains a pointed opener that penetrates the film of the working agent pouch from the inside out in order to start the cooling element.

9. A cooling element as defined in claim 1, wherein the working agent pouch is made of a film with peel effect that opens a sealing seam upon additional pressure.

10. A cooling element as defined in claim 1, wherein two or more working agent pouches are contained in one cooling element and can be started separately from each other.

11. A cooling element as defined in claim 10, wherein the amount of working agent fill in a working agent pouch is less than the maximum amount of working agent that can be adsorbed by the sorption agent.

12. A cooling element as defined in claim 1, wherein a longer connecting path exists between a working agent pouch and the nonwoven, which allows the working agent pouch to be arranged at a distance from the evaporator region and to be started.

13. A cooling element as defined in claim 12, wherein the connecting conduit is formed by a flexible tube within the multilayer film.

14. A cooling element as defined in claim 1, wherein the cooling element is put into a cape-like shape and its evaporator region cools the cylindrical part of a bottle.

15. A cooling element as defined in claim 1, wherein the evaporator region is provided with an additional thermal insulation.

16. A cooling element as defined in claim 1, wherein the nonwoven has structurings or depressions in which the multilayer film is drawn under vacuum in order to accept changes of length that arise in the flexible forming process.

17. A cooling element as defined in claim 1, wherein the sorption agent region is divided into several pockets by sealing seams, so that the sorption agent region is also flexible along the sealing seams.

18. A method for producing a cooling element as defined in claim 1, wherein the hot sorption agent is filled into the cooling element and evacuated via the structural material until the working agent evaporating from the sorption agent has displaced residual gases, and then the cooling element is sealed gas-tight while still under vacuum.

19. A method for producing a cooling element as defined in claim 1, wherein the hot sorption agent is filled into a sorption agent pouch, the still-open sorption agent pouch is then evacuated until the working agent evaporating from the sorption agent has displaced residual gases from the sorption agent pouch and then the sorption agent pouch is welded gas-tight while still under vacuum, and then the sorption agent pouch together with a shutoff device, the structural material and the nonwoven soaked in the working agent are placed into a gas-tight envelope pouch and the envelope pouch is sealed after being evacuated to under 5 mbar (abs.).

20. A method for producing a cooling element as defined in claim 1, wherein the sorption agent is filled into the multilayer film at temperatures between 120 and 250° C.

21. A method for starting the cooling function of the cooling element as defined in claim 1, wherein an opening at least 1 cm² in size from the evaporator region to the sorption agent is made free by a vigorous blow to the shutoff device.

22. A method for starting the cooling function of the cooling element as defined in claim 1, wherein, through additional pressure on the working agent pouch, an inner opener perforates the working agent pouch and the working agent flows out.

23. A method for using a cooling element as defined in claim 1, wherein the containers to be cooled contain liquids that are cooled at a cooling rate of more than 0.5 K/min (0.5 Kelvins per minute).

24. A method using a cooling element as defined in claim 1, wherein, if more than one working agent pouch is present, only one working agent pouch is opened each time and the additional pouches are left unopened for a cooling function to take place at a later time.
